(19) United States
(12) Patent Application Publication
(10) Pub. No.: US 2018/0155068 A1
(43) Pub. Date: Jun. 7, 2018

(54) Filling Assembly

(71) Applicant: 3P Innovation Limited, Warwick, Warwickshire (GB)

(72) Inventors: Thomas Bailey, Warwick (GB); Andrew Cleall, Warwick (GB)

(73) Assignee: 3P Innovation Limited, Warwick, Warwickshire (GB)

(21) Appl. No.: 15/572,556

(22) PCT Filed: Jun. 29, 2016
(86) PCT No.: PCT/GB2016/051943

§ 371 Date: Nov. 8, 2017

(30) Foreign Application Priority Data
May 15, 2015 (GB) 1508320.7

(51) Int. Cl. B65B 1/08; B65B 1/32; B65B 39/00; A61J 1/00

(52) U.S. Cl. CPC B65B 1/08; B65B 1/32; B65B 1/06; A61J 1/00; B65B 39/00

(57) ABSTRACT

There is described a pharmaceutical container filler assembly for filling said container with a pharmaceutical powder material, which assembly comprises: means for supporting a pharmaceutical container; a reservoir suitable for holding a bulk pharmaceutical powder, wherein the powder reservoir is connected to a filler nozzle; said filler nozzle being adapted to be located in or adjacent to the pharmaceutical container such that the pharmaceutical container can be filled with the pharmaceutical powder; characterised in that the assembly is provided with means for vibrating, such that at least a portion of the assembly can be vibrated.

### FIELD OF THE INVENTION

The present invention relates to apparatus for filling a container with one or more pharmaceutical ingredients.

More particularly, the invention relates to apparatus for filling a syringe or cartridge with one or more powdered pharmaceutical ingredients.

### BACKGROUND TO THE INVENTION

When filling pharmaceutical containers, such as, syringes, cartridges and the like, with a powdered pharmaceutical ingredient, it is essential for the powder to flow consistently and predictably, without blockage, to ensure, inter alia, that the correct volume or weight of pharmaceutical ingredient is placed in the container.

Also, when operating under conditions of real time weight control, such as the Fill2Weight™ process described in European Patent application No. 2590862 (WO 2012/004606), it is important for the powder to flow consistently and predictably.

Delivery of medicaments by injection or by inhalation will often require a significantly lower dosage of the medicament than conventional enteral drug delivery, e.g. in the form of a capsule or tablet. However, accurate and consistent dosing of a prefilled syringe or cartridge with a small amount of a pharmaceutical powder is difficult. In addition, in order to aid solubilisation and delivery syringe very fine powder medicaments may be preferred.

A further problem with accurate filling and measuring of fine powders is that air flow around the filling process may impede or disturb a weighing system or cell that forms an integral part of the control of the filling process.

Thus, there is an increasing need for an improved filling method and improved filling apparatus for accurately and consistently filling pharmaceutical containers, such as syringes or cartridges, with small doses of fine powders.

### SUMMARY OF THE INVENTION

We have now found an effective method and apparatus for filling a pharmaceutical container with a pharmaceutical powder device that overcomes or mitigates the problems associated with the prior art devices.

Thus, according to a first aspect of the invention there is provided a pharmaceutical container filler assembly for filling said container with a pharmaceutical powder material, which assembly comprises:
means for supporting a pharmaceutical container;
a reservoir suitable for holding a bulk pharmaceutical powder, wherein the powder reservoir is connected to a filler nozzle;
said filler nozzle being adapted to be located in or adjacent to the pharmaceutical container such that the pharmaceutical container can be filled with the pharmaceutical powder;
characterised in that the assembly is provided with means for vibrating, such that at least a portion of the assembly can be vibrated.

The filler nozzle will generally comprise a small diameter tube or a tube with a small diameter neck. By way of example only, such a small diameter tube or neck may typically have a diameter of from about 1 mm to about 5 mm. The use of a small diameter tube or a tube with a small diameter neck is advantageous in that it acts to protect the surrounding surfaces from contamination which could affect the seal integrity of the container when it is capped/sealed. Furthermore, the small diameter tube or tube with a small diameter neck may act as a funnel for the pharmaceutical powder to be transferred from the reservoir to the pharmaceutical container.

The term pharmaceutical container will be understood by the person skilled in the art and may comprise, for example, syringe or other injection device, vial, cartridge, capsule, blisters or inhaler and the like.

In one aspect of the invention the portion of the assembly which is vibrated is the pharmaceutical container when it is in situ. However, in a preferred aspect of the invention the portion of the assembly which is vibrated is filling portion, i.e. the reservoir and/or the filler nozzle. In an especially preferred aspect of the invention, it is the filler nozzle which is vibrated.

The frequency of the vibration may vary depending, inter alia, upon the nature of the powder, the container, etc. However, generally the frequency of the vibration may be from about 25 to about 2000 Hertz, or from about 50 to about 2000 Hertz, or from about 100 to about 1800 Hertz, or from about 200 to about 1600 Hertz, or from about 300 to about 1400 Hertz, or from about 400 to about 1200 Hertz. Most preferably the vibration frequency is from about 500 to about 1000 Hertz. By way of example only, such frequency may typically be suitable used for powdered pharmaceuticals of which a mean particle size of from about 0.2 to about 200 μm.

Similarly, the amplitude of the vibration may vary. Typically the amplitude may be from about 0.05 to about 1 mm, or from about 0.05 to about 0.5 mm, or from about 0.06 to about 0.45 mm, or from about 0.07 to about 0.4 mm, or from about 0.08 to about 0.35 mm, or from about 0.09 to about 0.3 mm. Most preferably the amplitude of the vibration is from about 0.1 to about 0.25 mm.

The means for vibrating may comprise a variety of mechanical or electrical vibration mechanisms may suitably be used in the assembly of the present invention. Such vibration mechanisms will be known to the person skilled in the art. However, a preferred vibrator comprises an electrical vibration mechanism, such as a piezoelectric vibrator. Piezoelectric vibrators utilising a piezoelectric crystal or the like are known. For example, such piezoelectric crystal vibrators are used in mobile phones. Advantageously, the piezoelectric vibrator does not include many moving mechanical parts.

Suitably, a controller is provided for controlling supply (i.e., amplitude and/or frequency) of actuating electricity to the vibrator so as to cause vibration of the filler nozzle. The controller may include means for controlling the vibration frequency and/or amplitude for optimally filling the pharmaceutical container.

In use, the piezoelectric vibrator is operably linked to the portion of the assembly that is to be vibrated, e.g. the filler nozzle. The operable link may comprise a vibration arm linked at one end to the piezoelectric vibrator and at the other end being provided with means to engage with the filler nozzle. It will be understood by the person skilled in the art that, in use, the vibration arm may simply abut the filler nozzle or may engage with the filler nozzle, e.g. it may be provided with means for gripping the filler nozzle.

In use, the assembly is preferably oriented substantially vertically, i.e. such that the filling of the container form the reservoir may be gravity based.

The filler assembly of the invention may also be provided with means for delivering and/or measuring a precise predetermined amount of the pharmaceutical powder to the pharmaceutical container. Such means will generally be known to the person skilled in the art.

One example of means for measuring a precise predetermined amount of the powdered pharmaceutical comprises the use of weight control and verification. For example, the pharmaceutical container may be positioned one weight cell so that the amount of pharmaceutical powder filled into the pharmaceutical container can be accurately measured.

It is an important aspect of the invention that the pharmaceutical container can be subject to 100% weight verification and/or real time weight control. The proprietary Fill2Weight™ process fills to a target weight rather than dispenses a fixed volume, dynamically measuring, controlling and recording the dispensed weight of all doses. This allows for compensation to changes in powder properties, such as density, in real time and without user intervention or re-calibration. Fill2Weight™ directly fills reconstitutable injection devices, vials, cartridges, syringes, inhalers, or industry standard capsules and blisters with 100% weight verification and/or real time weight control. Quality can be enhanced with reduced dose weight variability, lower reject levels and 100% weight recording. Dispensed weight related batch rejection is eliminated.

However, one general difficulty with the technique of precise weight verification and/or real time weight control is that air flow turbulence, often created by air circulation in cleanrooms, downflow in sterile isolators or by air flow induced by mechanical or operator movements can disturb the weight cell and impede the accuracy of any weight measurement.

Thus, in a further embodiment of the invention the means for supporting the pharmaceutical container may include a damper. The damper may comprise a vibration damper suitable for limiting the impact of any vibrations on the accuracy of the weight measurement.

However, in a preferred embodiment the damper comprises a turbulence damper suitable for reducing disruption to the accuracy of the weight measurement by air turbulence.

In one particular aspect the invention the turbulence damper may comprise a turbulence reducing sleeve adapted to encase the pharmaceutical container during the filling process. Preferably the turbulence reducing sleeve may be provided with an internal mount (puck) upon which the pharmaceutical container can rest during the filling procedure.

However, it will be understood by the person skilled in the art that the use of a turbulence damper may be advantageous in any filling assembly which relies upon 100% weight verification and/or real time weight control as a means for measuring a precise predetermined amount of the powdered pharmaceutical. That is, the use of a turbulence damper may be advantageous even if the filling assembly is not provided with means for vibrating the filling nozzle. Such a filling assembly provided with a turbulence damper is novel per se.

Thus, in an additional aspect of the present invention there is provided a pharmaceutical container filler assembly for filling said container with a pharmaceutical powder material, which assembly comprises:
means for supporting a pharmaceutical container;
a reservoir suitable for holding a bulk pharmaceutical powder, wherein the powder reservoir is connected to a filler nozzle;
said filler nozzle being adapted to be located in or adjacent to the pharmaceutical container such that the pharmaceutical container can be filled with the pharmaceutical powder;
characterised in that the means for supporting a pharmaceutical container comprises a turbulence damper.

Thus, in a particular embodiment of this aspect of the invention there is provided a pharmaceutical container filler assembly as hereinbefore described which is suitable for real time weight control; and which includes means for supporting a pharmaceutical container which comprises a turbulence damper.

An important aspect of the use of a turbulence damper described herein is that the turbulence damper can suitably travel with the pharmaceutical container as opposed to some localised shields that move into place during filling at the filling station/point.

Furthermore, the internal mount (puck) provides support for the pharmaceutical container using external surfaces only. The internal mount (puck) locates the container precisely, enabling the filling tube/nozzle to be inserted without contact with the sides of the container neck, which can be critical with containers comprising a small diameter neck.

In addition, it is advantageous that the internal mount (puck) comprises an electrically conductive material, which may be earthed via the weigh cell. Such an electrically conductive internal mount (puck) is advantageous in that it can aid in dissipating static charge from plastic pharmaceutical containers. The presence of static charge is undesirable since it can impair the powder filling process and compromise cleanliness.

Thus, according to a further aspect of the invention there is provided a method of filling a pharmaceutical container with a pharmaceutical powder material, said method comprising the steps of:
providing a filler assembly comprising means for supporting a pharmaceutical container; a reservoir suitable for holding a bulk pharmaceutical powder, wherein the powder reservoir is connected to a filler nozzle; said filler nozzle being adapted to be located in or adjacent to the pharmaceutical container such that the pharmaceutical container can be filled with the pharmaceutical powder;
placing a pharmaceutical container in means for supporting a pharmaceutical container; and
vibrating at least a portion of the filler assembly.

In the method of the invention the person skilled in the art will understand that reference to filling a pharmaceutical container will encompass only partially filling such a container.

In a further aspect of the invention there is provided a method of filling a pharmaceutical container with a pharmaceutical powder material, said method comprising the steps of:
providing a filler assembly comprising means for supporting a pharmaceutical container; a reservoir suitable for holding a bulk pharmaceutical powder, wherein the powder reservoir is connected to a filler nozzle; said filler nozzle being adapted to be located in or adjacent to the pharmaceutical container such that the pharmaceutical container can be filled with the pharmaceutical powder;
placing a pharmaceutical container in means for supporting a pharmaceutical container; and
wherein the means for supporting a pharmaceutical container comprises a turbulence damper.

The invention further provides a pharmaceutical container filled with a pharmaceutical powder material using an assembly or a method as hereinbefore described.

The invention also provides the use of a pharmaceutical container filler assembly as hereinbefore described for filling a pharmaceutical powder into a pharmaceutical container.

The term powder used herein shall include any fine, loose, substantially free flowing particles, including, for example, dry powders, granules, pellets, microspheres, and the like.

The invention will now be illustrated by way of example only and with reference to the accompanying figures in which:

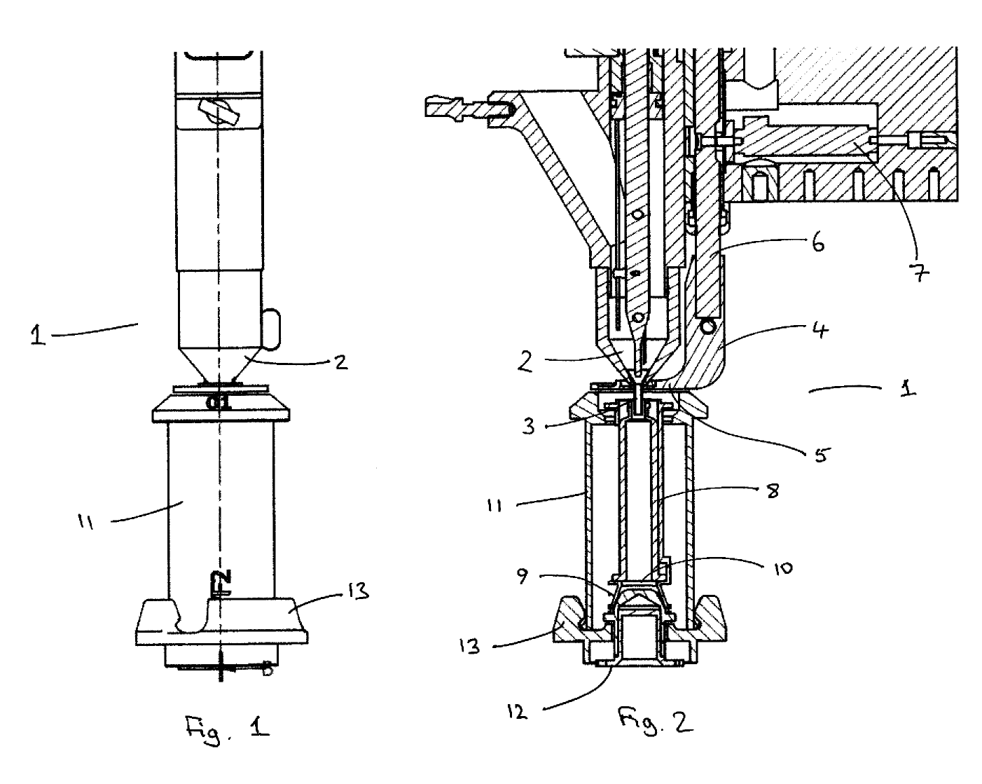

FIG. 1 is a side view of a filler assembly of the present invention, including a turbulence damper; and

FIG. 2 is a cross-sectional view of a filler assembly of the present invention, including a turbulence damper and a piezoelectric actuator.

Referring to FIG. 1 a pharmaceutical container filler assembly (1) comprises a powder reservoir (2) provided with a filler nozzle (not shown). The filler nozzle protrudes into a pharmaceutical container (not shown) which is located on a container support comprising a turbulence damper (11) located onto a sleeve base (13).

Referring to FIG. 2 a pharmaceutical container filler assembly (1) comprises a powder reservoir (2) provided with a filler nozzle (3). The filler nozzle (3) is linked to or abuts one end (4) of a vibration arm (5). The other end (6) of the vibration arm (5) is operably linked to a piezoelectric vibrator (7).

The filler nozzle (3) protrudes into a pharmaceutical container (8). The pharmaceutical container (8) is located on a container support (9) which comprises a mount (10) (puck) and a turbulence damper (11). The turbulence damper (11) in the form of a turbulence reducing sleeve substantially surrounds the pharmaceutical container (8). The mount (10) is itself located on a weigh cell (12). The turbulence damper or turbulence reducing sleeve (11) is located onto a sleeve base (13) which centralises the turbulence reducing sleeve (11) and allows the internal mount (puck) to lifted clear for weighing purposes.

In use the pharmaceutical powder is dispensed from the powder reservoir (2) through the filler nozzle (3) into the pharmaceutical container (8), e.g. syringe or cartridge. The piezoelectric vibrator (7) is actuated and vibration is transferred from the vibrator (7) to the filler nozzle (3) via the vibration arm (5). A predetermined amount of pharmaceutical powder is filled into the pharmaceutical container (8), which is measured using the weigh cell (12) in a proprietary Fill2Weight™ process.

1. A pharmaceutical container filler assembly for filling said container with a pharmaceutical powder material, which assembly comprises:
means for supporting a pharmaceutical container;
a reservoir suitable for holding a bulk pharmaceutical powder, wherein the powder reservoir is connected to a filler nozzle;
said filler nozzle being adapted to be located in or adjacent to the pharmaceutical container such that the pharmaceutical container can be filled with the pharmaceutical powder;
characterised in that the assembly is provided with means for vibrating, such that at least a portion of the assembly can be vibrated.

2. A pharmaceutical container filler assembly according to claim 1 wherein the filler nozzle comprises a small diameter tube or a tube with a small diameter neck.

3. A pharmaceutical container filler assembly according to claim 1 wherein the filling portion of the assembly, i.e. the reservoir and/or the filler nozzle, is vibrated.

4. A pharmaceutical container filler assembly according to claim 3 or wherein the filler nozzle is vibrated.

5. A pharmaceutical container filler assembly according to claim 1 wherein the frequency of the vibration is from about 25 to about 2000 Hertz.

6. (canceled)

7. A pharmaceutical container filler assembly according to claim 1 wherein the amplitude of the vibration is from about 0.05 to about 1 mm.

8. (canceled)

9. A pharmaceutical container filler assembly according to claim 1 wherein the means for vibrating comprises an electrical vibration mechanism.

10. (canceled)

11. A pharmaceutical container filler assembly according to claim 1 wherein the means for vibrating is operably linked to the filler nozzle.

12. (canceled)

13. A pharmaceutical container filler assembly according to claim 1 wherein the filler assembly is provided with means for delivering and/or measuring a precise predetermined amount of the pharmaceutical powder to the pharmaceutical container.

14. A pharmaceutical container filler assembly according to claim 13 wherein the means for measuring a precise predetermined amount of the powdered pharmaceutical comprises the use of weight control and verification.

15. A pharmaceutical container filler assembly according to claim 1 wherein the means for supporting the pharmaceutical container includes a damper.

16.-17. (canceled)

18. A pharmaceutical container filler assembly according to claim 1 wherein the turbulence damper comprises a turbulence reducing sleeve adapted to encase the pharmaceutical container during the filling process.

19. A pharmaceutical container filler assembly according to claim 18 wherein the turbulence reducing sleeve is provided with an internal mount upon which the pharmaceutical container can rest during the filling procedure.

20. A pharmaceutical container filler assembly according to claim 19 wherein the internal mount is adapted to locate the pharmaceutical container precisely enabling the filling tube/nozzle to be inserted without contact with the sides of the container neck.

21.-22. (canceled)

23. A pharmaceutical container filler assembly for filling said container with a pharmaceutical powder material, which assembly comprises:
means for supporting a pharmaceutical container;
a reservoir suitable for holding a bulk pharmaceutical powder, wherein the powder reservoir is connected to a filler nozzle;
said filler nozzle being adapted to be located in or adjacent to the pharmaceutical container such that the pharmaceutical container can be filled with the pharmaceutical powder;
characterised in that the means for supporting a pharmaceutical container comprises a turbulence damper.

24.-29. (canceled)

30. A method of filling a pharmaceutical container with a pharmaceutical powder material, said method comprising the steps of:
providing a filler assembly comprising means for supporting a pharmaceutical container; a reservoir suitable for holding a bulk pharmaceutical powder, wherein the powder reservoir is connected to a filler nozzle; said filler nozzle being adapted to be located in or adjacent to the pharmaceutical container such that the pharmaceutical container can be filled with the pharmaceutical powder;
placing a pharmaceutical container in means for supporting a pharmaceutical container; and
vibrating at least a portion of the filler assembly.

31. A method according to claim 30 or wherein the filler nozzle is vibrated.

32. A method of filling a pharmaceutical container with a pharmaceutical powder material, said method comprising the steps of:
providing a filler assembly comprising means for supporting a pharmaceutical container; a reservoir suitable for holding a bulk pharmaceutical powder, wherein the powder reservoir is connected to a filler nozzle; said filler nozzle being adapted to be located in or adjacent to the pharmaceutical container such that the pharmaceutical container can be filled with the pharmaceutical powder;
placing a pharmaceutical container in means for supporting a pharmaceutical container; and
wherein the means for supporting a pharmaceutical container comprises a turbulence damper.

33. A method according to claim 32 or wherein the filler nozzle is vibrated.

34. A pharmaceutical container filled with a pharmaceutical powder material using an assembly according to claim 1.

35. (canceled)

36. A pharmaceutical container filled with a pharmaceutical powder material using a method according to claim 30.

37.-40. (canceled)
